(19) United States
(12) Patent Application Publication
(10) Pub. No.: US 2020/0409111 A1
(43) Pub. Date: Dec. 31, 2020

(54) OPTICAL LENS MODULE

(71) Applicant: AAC Optics Solutions Pte. Ltd., Singapore city (SG)

(72) Inventor: Jie Ma, Shenzhen (CN)

(21) Appl. No.: 16/914,374

(22) Filed: Jun. 28, 2020

(30) Foreign Application Priority Data
Jun. 28, 2019 (CN) PCT/CN2019/093905

(51) Int. Cl. G02B 13/00; G02B 7/02; G02B 1/04; H04N 5/225; G02B 27/00

(52) U.S. Cl. CPC G02B 13/0045; G02B 7/026; G02B 27/0018; G02B 1/04; H04N 5/2254; G02B 7/021

(57) ABSTRACT

Provided is an optical lens module, including a lens barrel, a lens assembly including first and second lenses, and a press ring. The first lens includes a first object side surface, a first image side surface, and a circumferential surface connecting the first object side surface with the first image side surface. The first image side surface includes a first inclined surface directly connected to the circumferential surface. The second lens includes a second object side surface, which includes a first horizontal surface and a second inclined surface and abutting against the first inclined surface. The press ring abuts against the first horizontal surface and includes an inner ring surface connected to the circumferential surface, and an outer ring surface connected to the lens barrel. Such a design can greatly reduce the outer diameter of the first lens, thereby alleviating the appearance problems such as flow marks and air trapping.

### TECHNICAL FIELD

The present invention relates to the technical field of optical imaging, and in particular, to an optical lens module.

### BACKGROUND

Currently, optical lens modules have been widely used in various electronic products, such as mobile phones, tablets, etc. With development of camera technologies and increasing demands on electronic products, the optical lens modules are becoming more miniaturized, which in return increases difficulty in shaping of lenses, making it difficult to guarantee a surface shape of the lens.

Therefore, it is necessary to provide a lens module to solve the technical problems described above.

### SUMMARY

The present invention provides an optical lens module, aiming to solve a problem of difficulty in shaping of lenses of a traditional optical lens module.

Technical solutions of the present invention will be described in the following.

Embodiments of the present invention provide an optical lens module, including: a lens barrel, a lens assembly and a press ring. The lens assembly includes a first lens and a second lens provided at an image side of the first lens. The first lens includes a first object side surface, a first image side surface, and a circumferential surface connecting the first object side surface with the first image side surface. At least a part of the first object side surface is located outside the lens barrel. The first image side surface includes a first inclined surface directly connected to the circumferential surface. The second lens is located in the lens barrel and includes a second object side surface. The second object side surface includes a first horizontal surface and a second inclined surface extending obliquely towards an image side of the optical lens module from the first horizontal surface. The second inclined surface abuts against the first inclined surface. The press ring abuts against the first horizontal surface and includes an inner ring surface and an outer ring surface that is opposite to the inner ring surface. The inner ring surface is connected to the circumferential surface, and the outer ring surface is connected to the lens barrel.

For the optical lens module, the circumferential surface of the first lens is directly connected to the first inclined surface. Such a design can greatly reduce the outer diameter of the first lens, thereby alleviating the appearance problems such as flow marks and air trapping. Moreover, when the first lens is formed by means of an injection molding process, a height of a gate can be increased, thereby greatly reducing difficulty in shaping of the first lens and thus improving a surface shape of the first lens.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a structure of an optical lens module according to an embodiment of present invention.

FIG. 2 is a schematic diagram of a structure of a lens barrel of the optical lens module shown in FIG. 1;

FIG. 3 is a schematic diagram of a structure of a first lens of the optical lens module shown in FIG. 1;

FIG. 4 is a schematic diagram of a structure of a second lens of the optical lens module shown in FIG. 1;

FIG. 5 is a schematic diagram of a structure of a third lens of the optical lens module shown in FIG. 1;

FIG. 6 is a schematic diagram of a structure of a press ring of the optical lens module shown in FIG. 1; and

FIG. 7 is a schematic diagram of a structure of a first lens of a conventional optical lens module.

### DESCRIPTION OF EMBODIMENTS

The present invention will be further described in the following with reference to the accompany drawings and embodiments.

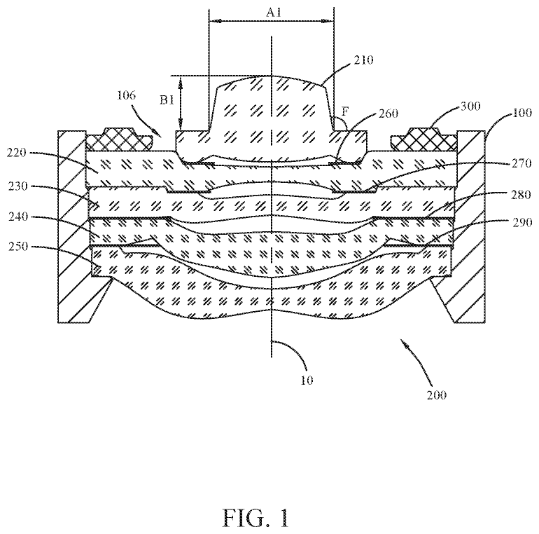

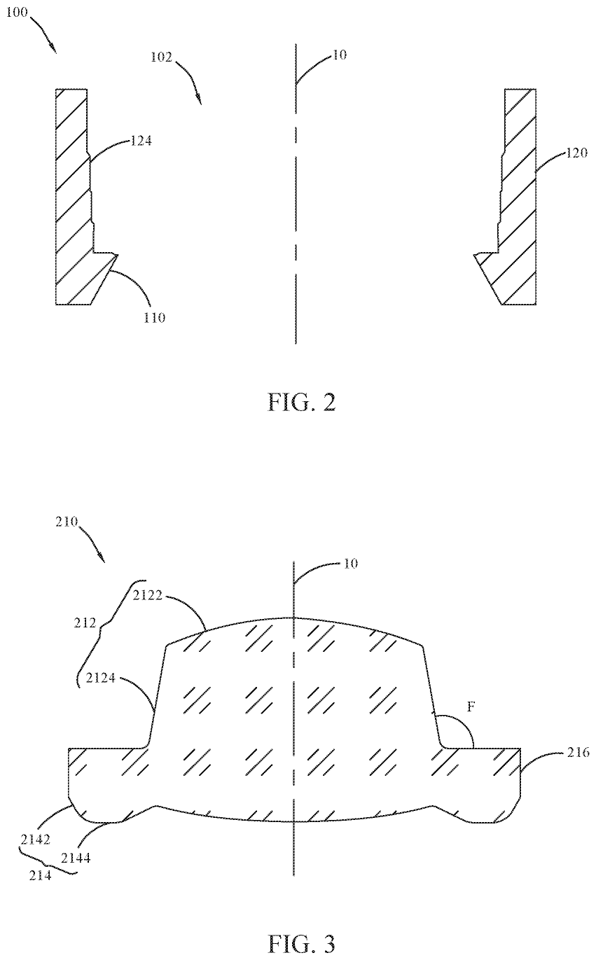

As shown in FIG. 1 and FIG. 2, in an embodiment of the present disclosure, the optical lens module can be applied to electronic products such as mobile phones and tablets. The optical lens module includes a lens barrel 100 and a lens assembly 200. The lens barrel 100 serves as a main installation structure for the lens assembly 200, and may be shaped as a cylinder or a square tube.

The lens barrel 100 includes a bottom wall 110 and a side wall 120. An end of the side wall 120 close to an object side is open. The bottom wall 110 is located at the end of the side wall 120 close to an image side and extends inwardly from the side wall 120 while being bent. The bottom wall 110 and the side wall 120 are connected together to form a receiving cavity 102. A surface of the side wall 120 close to the receiving cavity 102 is a step surface 124 with multiple steps. An inner diameter of the step surface 124 gradually increases along a direction from the object side towards the image side.

The lens assembly 200 includes a plurality of lenses sequentially arranged along the direction from the object side towards the image side, which includes a first lens 210, a second lens 220, a third lens 230, a fourth lens 240, and a fifth lens 250. That is, in this embodiment, the lens assembly 200 includes five lenses in total. An outer diameter of the first lens 210 is smaller than an outer diameter of the second lens 220. The outer diameter of the second lens 220, an outer diameter of the third lens 230, an outer diameter of the fourth lens 240, and an outer diameter of the fifth lens 250 gradually decrease. Therefore, it is understood that among the plurality of lenses, the first lens 210 is closest to the object side, the fifth lens 250 is closest to the image side, and the second lens 220 has the largest outer diameter.

Moreover, the second lens 220, the third lens 230, the fourth lens 240, and the fifth lens 250 are all located in the receiving cavity 102, and an image side surface of the fifth lens 250 abuts against the bottom wall 110. The respective outer diameters of these lenses are adapted to the corresponding inner diameter of the step surface 124, so as to prevent the lenses from a deviation with respect to a direction perpendicular to the optical axis 10.

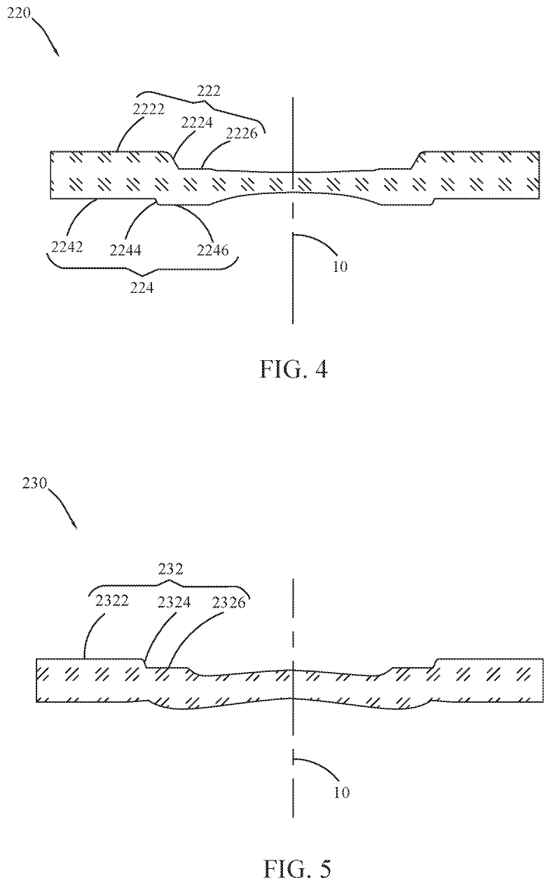

With reference to FIG. 1, FIG. 3 and FIG. 4, the first lens 210 includes a first object side surface 212, a first image side surface 214, and a circumferential surface 216 that connects the first object side surface 212 with the first image side surface 214. At least a part of the first object side surface 212 is located outside the lens barrel 100, and the first object side surface 212 includes a first curved surface 2122 and a second curved surface 2124 bent from the first curved surface 2122. Both the first curved surface 2122 and the second curved surface 2124 are located in an optical region of the first lens 210. In the direction from the object side towards the image side, the second curved surface 2124 is inclined along a direction facing away from the optical axis 10. In other words, in the direction from the object side towards the image side, a distance between the second curved surface 2124 and the optical axis 10 gradually increases. Since the first lens 210 is a plastic lens and is formed by an injection molding process, such design of the second curved surface 2124 can facilitate drafting of the first lens 210. In other embodiments, the first lens 210 may also be a glass lens. In this case, the second curved surface 2124 may also be designed as a cylindrical surface with the optical axis 10 as its axis. That is, a generatrix of the second curved surface 2124 is a straight line parallel to the optical axis 10.

The first image side surface 214 includes a first inclined surface 2142 directly connected to the circumferential surface 216, and the first inclined surface 2142 is inclined towards the optical axis 10 in the direction from the object side towards the image side. The circumferential surface 216 is a cylindrical surface with the optical axis 10 as its axis. The second lens 220 includes a second object side surface 222. The second object side surface 222 includes a first horizontal surface 2222 perpendicular to the optical axis 10, and a second inclined surface 2224 extending obliquely towards the image side from the first horizontal surface 2222. The second inclined surface 2224 is inclined towards the optical axis 10, and the second inclined surface 2224 abuts against the first inclined surface 2142. In this embodiment, an angle formed between the first inclined surface 2142 and the optical axis 10 ranges from 30° to 60°. In other embodiments, the angle formed between the first inclined surface 2142 and the optical axis 10 may be in another range.

It can be understood that for the optical lens module in this embodiment, the first lens 210 engages with the second lens 220, and a part of the first lens 210 extends outside the lens barrel 100. Therefore, the part of the first lens 210 outside the lens barrel 100 has a dimension A1, which determines a dimension of a head of the entire optical lens module. In this way, the dimension of the head of the optical lens module can be greatly decreased without being limited by a thickness of the wall of the lens barrel 100.

In a conventional first lens 210a as shown in FIG. 7, a horizontal extending surface 211a is further connected between a circumferential surface 216a and a first inclined surface 2142a of a first lens 210a. Thus, the first lens 210a of the conventional optical lens module has a relatively large outer diameter, and due to affections of optical parameters, production, etc., the first lens 210a might have a relatively small thickness ratio, which leads to difficulty in shaping of the first lens 210a. In this case, the surface shape of the first lens 210a cannot be guaranteed, and appearance problems such as flow marks and air trapping may appear.

Therefore, compared to the conventional optical lens module, the outer diameter of the first lens 210 according to the embodiment of the present disclosure is greatly decreased, which can alleviate the appearance problems such as flow marks and air trapping. As the outer diameter of the first lens 210 is decreased, a drafting angle F of the first lens 210 is increased, thereby facilitating demolding and thus improving an accuracy of manufacturing the optical lens module. The increase of the drafting angle F means that the dimension A1 of the head can be smaller than a dimension A2 of a head of the conventional optical lens module. Thus, the dimension of head of the optical lens module is decreased. Meanwhile, a dimension B1 of the first lens 210 is larger than a dimension B2 of the traditional optical lens module.

In addition, when the first lens 210 is formed by means of an injection molding process, a height of a gate can be increased, thereby greatly decreasing difficulty in shaping first lens 210 and thus improving the surface shape of the first lens 210.

In addition, in this embodiment, the second lens 220, the third lens 230, the fourth lens 240, and the fifth lens 250 may also be plastic lenses.

The lens assembly 200 further includes a first light-shielding sheet 260 provided between the first lens 210 and the second lens 220. In this embodiment, the first image side surface 214 further includes a first bearing surface 2144 connected to the first inclined surface 2142, and the second object side surface 222 further includes a second bearing surface 2226 connected to the second inclined surface 2224. Both the first bearing surface 2144 and the second bearing surface 2226 are perpendicular to the optical axis 10. The first light-shielding sheet 260 is sandwiched between the first bearing surface 2144 and the second bearing surface 2226. The first light-shielding sheet 260 has a function of blocking stray light, so as to prevent stray light from entering an imaging region, which would otherwise affect an imaging quality.

In this embodiment, the second lens 220 also engages with the third lens 230. In combination with FIG. 4 and FIG. 5, the second lens 220 further includes a second image side surface 224. The second image side surface 224 includes a second horizontal surface 2242, a third inclined surface 2244 connected to the second horizontal surface 2242, and a third bearing surface 2246 connected to the third inclined surface 2244. The second horizontal surface 2242 is perpendicular to the optical axis 10. The third inclined surface 2244 extends obliquely towards the image side from the second horizontal surface 2242. The third inclined surface 2244 is inclined towards the optical axis 10. The third bearing surface 2246 is parallel to the second horizontal surface 2242. The third lens 230 includes a third object side surface 232. The third object side surface 232 includes a third horizontal surface 2322, a fourth inclined surface 2324 connected to the third horizontal surface 2322, and a fourth bearing surface 2326 connected to the fourth inclined surface 2324. The third horizontal surface 2322 is perpendicular to the optical axis 10. The fourth inclined surface 2324 extends obliquely towards the image side from the third horizontal surface 2322. The fourth inclined surface 2324 is inclined towards the optical axis 10. The fourth bearing surface 2326 is parallel to the third horizontal surface 2322. The second horizontal surface 2242 abuts against the third horizontal surface 2322. The third inclined surface 2244 abuts against the fourth inclined surface 2324. The third bearing surface 2246 is opposite to the fourth bearing surface 2326.

With further reference to FIG. 1, the lens assembly 200 further includes a second light-shielding sheet 270 provided between the second lens 220 and the third lens 230. The second light-shielding sheet 270 is sandwiched between the third bearing surface 2246 and the fourth bearing surface 2326, so as to block stray light, thereby preventing stray light from entering the imaging region, which would otherwise affect the imaging quality.

Further, in this embodiment, the lens assembly 200 further includes a third light-shielding sheet 280 and a fourth light-shielding sheet 290. The third light-shielding sheet 280 is provided between the third lens 230 and the fourth lens 240, and the fourth light-shielding sheet 290 is provided between the fourth lens 240 and the fifth lens 250. Both the third light-shielding sheet 280 and the fourth light-shielding sheet 290 have functions of blocking stray light, thereby improving the imaging effect.

In this embodiment, the first light-shielding sheet 260, the second light-shielding sheet 270, the third light-shielding sheet 280 and the fourth light-shielding sheet 290 are all formed by black plastic materials by means of an injection molding process, so as to improve an accuracy of dimension. In this way, production errors will neither cause a decreased effect of blocking stray light nor shield too much effective imaging light, which would otherwise affect an imaging quality. In other embodiments, these light-shielding sheets may also be made by stamping a black thin film.

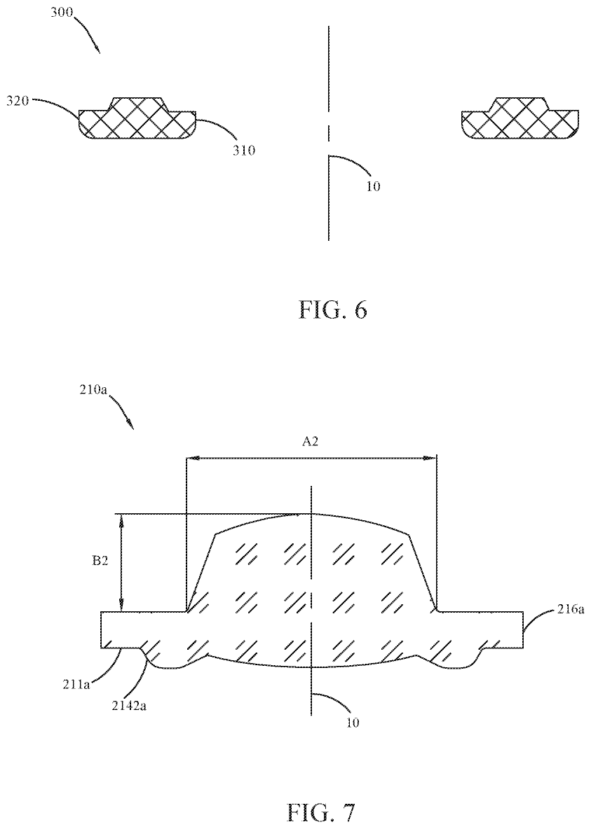

As shown in FIG. 1, FIG. 3, FIG. 4 and FIG. 6, the optical lens module further includes a press ring 300. The press ring 300 includes an inner ring surface 310 and an outer ring surface 320 that is opposite to the inner ring surface 310. The inner ring surface 310 is connected to the circumferential surface 216, so as to achieve a connection between the press ring 300 and the first lens 210. The outer ring surface 320 is connected to a surface of the side wall 120 close to the receiving cavity 102, so as to achieve a connection between the press ring 300 and the lens barrel 100. This can achieve fixing the first lens 210 to the lens barrel 100. Moreover, the press ring 300 abuts against the first horizontal surface 2222, in such a manner that the press ring 300 can cooperate with the bottom wall 110 to achieve fixing the second lens 220, the third lens 230, the fourth lens 240, and the fifth lens 250 to the lens barrel 100.

In this embodiment, the outer annular surface 320 is adhered to the lens barrel 100 by adhesive dispensing. Meanwhile, an adhesive receiving slot 106 is formed between the inner annular surface 310 and the circumferential surface 216. By dispensing adhesive into the adhesive receiving slot 106, the inner annular surface 310 is adhered to the circumferential surface 216. It can be understood that, in other embodiments, the press ring 300 may also be connected to the side wall 120 by a screw connection, which will not be limited herein.

When assembling the optical lens module in this embodiment, the fifth lens 250, the fourth lens 240, the third lens 230, the second lens 220, and the first lens 210 are sequentially assembled to the lens barrel 100 along the direction from the image side towards the object side, and finally, fixing of the lens assembly 200 is achieved by the press ring 300.

In addition, it should be noted that a number of lenses included in the lens assembly 200 is not limited to the embodiment shown in FIG. 1, and the number of lenses may also be 2, 3, 4, or larger than 6.

The above-described embodiments are merely preferred embodiments of the present invention. Various modifications can be made by those skilled in the art without departing from a concept of the present invention, and all these modifications shall fall into a protection scope of the present invention.

What is claimed is:

1. An optical lens module, comprising:
a lens barrel;
a lens assembly comprising a first lens and a second lens provided at an image side of the first lens, wherein the first lens comprises a first object side surface, a first image side surface, and a circumferential surface connecting the first object side surface with the first image side surface; at least a part of the first object side surface is located outside the lens barrel, the first image side surface comprises a first inclined surface directly connected to the circumferential surface, the second lens is located in the lens barrel and comprises a second object side surface, the second object side surface comprises a first horizontal surface and a second inclined surface extending obliquely towards an image side of the optical lens module from the first horizontal surface, and the second inclined surface abuts against the first inclined surface; and
a press ring abutting against the first horizontal surface and comprising an inner ring surface and an outer ring surface that is opposite to the inner ring surface, wherein the inner ring surface is connected to the circumferential surface, and the outer ring surface is connected to the lens barrel.

2. The optical lens module as described in claim 1, wherein an angle formed between the first inclined surface and an optical axis of the optical lens module ranges from 30° to 60°.

3. The optical lens module as described in claim 1, wherein the first object side surface comprises a first curved surface and a second curved surface extending from the first curved surface while being bent, both the first curved surface and the second curved surface are located in an optical region of the first lens, and in a direction from an object side towards the image side of the optical lens module, the second curved surface is inclined along a direction facing away from the optical axis of the optical lens module.

4. The optical lens module as described in claim 1, wherein the inner annular surface is adhered to the circumferential surface, an adhesive receiving slot is formed between the inner annular surface and the circumferential surface, and the outer annular surface is adhered to the lens barrel.

5. The optical lens module as described in claim 1, wherein the lens assembly comprises a first light-shielding sheet provided between the first lens and the second lens.

6. The optical lens module as described in claim 5, wherein the first image side surface further comprises a first bearing surface connected to the first inclined surface, the second object side surface further comprises a second bearing surface connected to the second inclined surface, and the first light-shielding sheet is sandwiched between the first bearing surface and the second bearing surface.

7. The optical lens module as described in claim 1, wherein the lens assembly further comprises a third lens provided at an image side of the second lens, and a second light-shielding sheet provided between the second lens and the third lens; and an outer diameter of the third lens is smaller than an outer diameter of the second lens.

8. The optical lens module as described in claim 7, wherein the second lens further comprises a second image side surface, and the second image side surface comprises a second horizontal surface, a third inclined surface connected to the second horizontal surface, and a third bearing surface connected to the third inclined surface; the third inclined surface extends obliquely towards the image side of the optical lens module from the second horizontal surface, the third lens comprises a third object side surface, and the third object side surface comprises a third horizontal surface, a fourth inclined surface connected to the third horizontal surface, and a fourth bearing surface connected to the fourth inclined surface; the fourth inclined surface extends obliquely towards the image side of the optical lens module from the third horizontal surface, the second horizontal surface abuts against the third horizontal surface, the third inclined surface abuts against the fourth inclined surface, and the second light-shielding sheet is sandwiched between the third bearing surface and the fourth bearing surface.

9. The optical lens module as described in claim 7, wherein the lens assembly further comprises a fourth lens and a fifth lens; and in a direction from an object side towards the image side of the optical lens module, the third lens, the fourth lens and the fifth lens are sequentially arranged, and outer diameters of the third lens, the fourth lens and the fifth lens gradually decrease; and
the lens assembly further comprises a third light-shielding sheet provided between the third lens and the fourth lens and a fourth light-shielding sheet provided between the fourth lens and the fifth lens.

10. The optical lens module as described in claim 1, wherein the first lens is a plastic lens and the second lens is a plastic lens.
